(19) United States
(12) Patent Application Publication
(10) Pub. No.: US 2024/0380712 A1
(43) Pub. Date: Nov. 14, 2024

(54) CHAT-BASED COLLABORATIVE DEVELOPMENT ENVIRONMENT

(71) Applicant: Trixta, Inc., Phoenix, AZ (US)

(72) Inventors: Mark Levitt, Phoenix, AZ (US); Barry Worthington Hill, Phoenix, AZ (US)

(73) Assignee: Trixta, Inc., Phoenix, AZ (US)

(21) Appl. No.: 18/657,066

(22) Filed: May 7, 2024

Related U.S. Application Data
(60) Provisional application No. 63/501,246, filed on May 10, 2023.

(51) Int. Cl. H04L 51/04

(52) U.S. Cl. CPC H04L 51/04

(57) ABSTRACT

A system and method for software development are provided. The method includes providing a chat function for chat between participants accessing a development environment via respective user terminals and obtaining chat text from the chat between the participants. The method includes inputting the chat text into one or more context-linked agent components, each being associated with a context of development. The method includes receiving, by each of the context-linked agent components, chat text from the chat between participants and using the chat text to obtain a text-based output relating to the context of development. The text-based output being obtained from a language model configured for the context of development. The method includes outputting a visual representation of the text-based output to a user interface of the development environment being displayed on each of the user terminals for interaction therewith by one or more of the participants via the user interface.

### CROSS-REFERENCE(S) TO RELATED APPLICATIONS

This application claims priority from U.S. provisional patent application No. 63/501,246 filed on 10 May 2023, which is incorporated by reference herein.

### FIELD

This disclosure relates to a system and method for software development. More particularly, although not exclusively, this disclosure relates to software program development tools, for example for code generation and/or modification. In particular, although not exclusively, this disclosure relates to a system and method for providing a chat-based collaborative development environment for application software development.

### BACKGROUND

A software development environment typically includes a set of tools for use by software developers in creating application software. Increasingly, software developers and other individuals collaborate with one another in developing given application software. Collaboration tools provided by existing development environments, however, lack suitable integration between software developers and development tools, which may hinder effective or efficient development of application software.

Accordingly, there is scope for improvement.

The preceding discussion of the background is intended only to facilitate an understanding of the present disclosure. It should be appreciated that the discussion is not an acknowledgment or admission that any of the material referred to was part of the common general knowledge in the art as at the priority date of the application.

### SUMMARY

In accordance with an aspect of the disclosure there is provided a system comprising a non-transitory computer-readable storage medium and one or more processors coupled to the non-transitory computer-readable storage medium, wherein the non-transitory computer-readable storage medium comprises program instructions that, when executed on the one or more processors, cause the system to perform operations comprising: providing a chat function for chat between participants accessing a development environment via respective user terminals; obtaining chat text from the chat between the participants; inputting the chat text into each of one or more context-linked agent components, each of which is associated with a context of development; receiving, by each of the one or more context-linked agent components, chat text from the chat between participants and using the chat text to obtain a text-based output relating to the context of development, the text-based output being obtained from a language model configured for the context of development; and, outputting a visual representation of the text-based output to a user interface of the development environment being displayed on each of the user terminals for interaction therewith by one or more of the plurality of participants via the user interface.

The context of development may define a part of a codebase under development which is associated with a function. The part of the codebase may include one or more blocks of code. The context-linked agent component may be a primitive element agent component associated with a primitive element. The primitive element may define the context of development. The primitive element may be associated with the part of the codebase under development.

The chat between the participants may include voice chat. Obtaining chat text from the chat between the participants may include converting a recording of the voice chat to text. The development environment may provide primitive elements for each of each of: a space; a role; an agent; an interaction (action or reaction); a flow; and a step. The development environment may provide a primitive element agent component for the primitive elements for each of each of: the space; the role; the agent; the interaction (action or reaction); the flow; and the step.

Each of the one or more context-linked agent components has access to a language model fine-tuned based on the context of development with which it is associated. Fine-tuning the language model may include using a data structure including a mapping of sample prompts relating to that context of development to sample text-based outputs relating to the sample prompts.

The program instructions may cause the system to perform operations including, by each of the one or more context-linked agent components, compiling a prompt based on the chat text; and, inputting the prompt into the language model. Compiling the prompt may include inserting the chat text or one or more keywords or key phrases obtained therefrom into placeholders of a predefined prompt. The predefined prompt may be specific to the context of development with which the context-linked agent component is associated.

The program instructions may cause the system to perform operations including, by each of the one or more context-linked agent components, receiving the text-based output from the language model. Different variants of the language model for each of the different context-linked agent components may generate different formats of text-based output, including one or more of: a list of roles; a list of actions; a list of agents; and, a configured instance of a primitive element. The text-based output may include the configured instance of the primitive element, the configured instance being configured in accordance with the chat text.

The program instructions may cause the system to perform operations including, by each of the one or more context-linked agent components, outputting, via a graphical element rendering and display component, a graphical element in the form of a visual representation of the configured instance of the primitive element to the user interface. The graphical element may be output for further configuration via the user interface.

The text-based output may be in the form of a schema validation-based file representing structured data, wherein the schema validation-based file defines user-input fields and associated validation rules for the user-input fields for further configuration via the user interface.

The program instructions may cause the system to perform operations including, by the graphical element rendering and display component: receiving the schema validation-based file from the model; generating a graphical element in the form of a visual representation of the schema validation-based file based on display rules configured to define how the user interface displays the graphical element, including display of user-input fields for receiving user input associated with the graphical element; and, outputting the graphical element to the user interface.

The program instructions may cause the system to perform operations including, by each of the one or more context-linked agent components: receiving user input in relation to the text-based output of the language model; and, updating or adjusting the text-based output based on the user input and/or inputting into the language model the user input as feedback on the text-based output generated for the prompt.

The user-input may include data points entered into a user-input field of the configured instance of the primitive element, and the program instructions may cause the system to perform operations including: validating the user input based on validation rules of the primitive element; generating configuration values (such as JSON configuration values) based on validated data points; and, converting the configuration values into configuration code based on the validated data points.

In accordance with another aspect of the disclosure there is provided a computer-implemented method comprising: providing a chat function for chat between participants accessing a development environment via respective user terminals; obtaining chat text from the chat between the participants; inputting the chat text into each of one or more context-linked agent components, each of which is associated with a context of development; receiving, by each of the one or more context-linked agent components, chat text from the chat between participants and using the chat text to obtain a text-based output relating to the context of development, the text-based output being obtained from a language model configured for the context of development; and, outputting a visual representation of the text-based output to a user interface of the development environment being displayed on each of the user terminals for interaction therewith by one or more of the plurality of participants via the user interface.

The chat may include voice chat and obtaining chat text from the chat between the participants may include converting the voice chat into text.

The method may include each of the one or more context-linked agent components: compiling a prompt based on the chat text; and, inputting the prompt into the language model. Compiling the prompt may include inserting the chat text or one or more keywords or key phrases obtained therefrom into placeholders of a predefined prompt. The predefined prompt may be specific to the context of development with which the context-linked agent component is associated.

The method may include each of the one or more context-linked agent components receiving the text-based output from the language model.

Different variants of the language model for each of the different context-linked agent components may generate different formats of text-based output, including one or more of: a list of roles; a list of actions; a list of agents; and, a configured instance of a primitive element.

The text-based output may include a configured instance of a primitive element, the configured instance being configured in accordance with the chat text.

The method may include each of the one or more context-linked agent components outputting a graphical element in the form of a visual representation of a configured instance of a primitive element to the user interface, wherein the graphical element is output for further configuration via the user interface.

The text-based output may be in the form of a schema validation-based file representing structured data, wherein the schema validation-based file defines user-input fields and associated validation rules for the user-input fields for further configuration via the user interface.

The method may include: receiving the schema validation-based file; generating a graphical element in the form of a visual representation of the schema validation-based file based on display rules configured to define how the user interface displays the graphical element, including display of user-input fields for receiving user input associated with the graphical element; and, outputting the graphical element to the user interface.

The method may include each of the one or more context-linked agent components: receiving user input in relation to the text-based output of the language model; and, updating or adjusting the text-based output based on the user input and/or inputting into the language model the user input as feedback on the text-based output generated for the prompt.

The user-input may include data points entered into a user-input field of the configured instance of the primitive element, and the method may include: validating the user input based on validation rules of the primitive element; generating configuration values (such as JSON configuration values) based on validated data points; and, converting the configuration values into configuration code based on the validated data points.

In accordance with a further aspect of the disclosure there is provided a computer program product comprising a computer-readable medium having stored computer-readable program code for performing the steps of: providing a chat function for chat between participants accessing a development environment via respective user terminals; obtaining chat text from the chat between the participants; inputting the chat text into each of one or more context-linked agent components, each of which is associated with a context of development; receiving, by each of the one or more context-linked agent components, chat text from the chat between participants and using the chat text to obtain a text-based output relating to the context of development, the text-based output being obtained from a language model configured for the context of development; and, outputting a visual representation of the text-based output to a user interface of the development environment being displayed on each of the user terminals for interaction therewith by one or more of the plurality of participants via the user interface

Further features provide for the computer-readable medium to be a non-transitory computer-readable medium and for the computer-readable program code to be executable by a processing circuit.

In accordance with a further aspect of the disclosure there is provided a system including a memory for storing computer-readable program code and a processor for executing the computer-readable program code, the system providing a chat-based collaborative development environment accessible to a plurality of participants via respective user terminals, the development environment comprising: a chat engine which provides a chat function for chat between the participants accessing the development environment; a chat text obtaining component for obtaining chat text from the chat between the participants; and, one or more primitive element agent components, each of which is associated with a primitive element and is configured to receive text from the chat text obtaining component; to use the text to obtain a text-based output relating to the primitive element, the text-based output being obtained from a language model configured for the primitive element; and to output a visual representation of the text-based output to a user interface of the development environment being displayed on each of the user terminals for interaction therewith by one or more of the plurality of participants via the user interface.

There may be a primitive element agent component for primitive elements for each of each of: a space; a role; an agent; an interaction (action or reaction); a flow; and a step. Each of the one or more primitive element agent components may have access to a language model fine-tuned based on the primitive element with which it is associated. Fine-tuning the language model may include using a data structure including a mapping of sample prompts relating to that primitive element to sample text-based outputs relating to the sample prompts. Each of the one or more primitive element agent components may include a prompting component configured to: compile a prompt based on the text; and, input the prompt into the language model. Compiling the prompt may include inserting the text or one or more keywords or key phrases obtained therefrom into placeholders of a predefined prompt. The predefined prompt may be specific to the primitive element with which the primitive element agent component is associated. Each of the one or more primitive element agent components may include a model output receiving component configured to receive a text-based output from the language model. Different variants of the language model for each of the different primitive element agent components may generate different formats of text-based output, including one or more of: a list of roles; a list of actions; a list of agents; and, the configured instance of the primitive element. The text-based output may include a configured instance of the primitive element, the configured instance being configured in accordance with the text. The primitive element agent component may be configured to output, via a graphical element rendering and display component, a graphical element in the form of a visual representation of the configured instance of the primitive element to the user interface, wherein the graphical element is output for further configuration via the user interface.

The text-based output may be in the form of a schema validation-based file representing structured data, wherein the schema validation-based file defines user-input fields and associated validation rules for the user-input fields for further configuration via the user interface. The graphical element rendering and display component may be configured to: receive the schema validation-based file from the model output receiving component; generate a graphical element in the form of a visual representation of the schema validation-based file based on display rules configured to define how the user interface displays the graphical element, including display of user-input fields for receiving user input associated with the graphical element; output the graphical element to the user interface.

Each of the one or more primitive element agent components may be configured to: receive user input in relation to the text-based output of the language model; and, to update or adjust the text-based output based on the user input and/or to input into the language model the user input as feedback on the text-based output generated for the prompt.

The user-input may include data points entered into a user-input field of the configured instance of the primitive element, and the development environment may include: a validation component configured to validate the user input based on validation rules of the primitive element; and a configuration component configured to: generate configuration values (such as JSON configuration values) based on validated data points; and convert the configuration values into configuration code based on the validated data points.

In accordance with a further aspect of the disclosure there is provided a computer implemented method for executing a development environment comprising: receiving, from a participant, a primitive element initiation request relating to initiation of a primitive element selected from: a space, a role, an action, a flow and a step; in response to receiving the request: initiating a process representing an instance of the primitive element on one or more nodes, the process including a mailbox via which one more messages from other processes are received and stored until read; allocating a portion of memory dedicated to the process and which represents a state machine for the instance of the primitive element, wherein the portion of memory is provided by a distributed database management system accessible by the one or more nodes; initiating an agent component associated with the instance of the primitive element; associating the process with one or more other processes based on an association between the instance of the primitive element and other instances of the primitive element or instances of other primitive elements such that messages can be exchanged between the process and the other processes; and, outputting a graphical representation of the instance of the primitive element via a graphical user interface in which the association between the instance of the primitive element and the other instances of the primitive element or the instances of other primitive elements is rendered graphically; wherein the process is addressable by and can address the other processes with which it is associated for sending and receiving messages, and wherein in response to receiving a message from another process, the method includes updating the state machine for the instance of the primitive element based on content of the message such that the updated state machine is accessible to the one or more nodes executing the process.

The method may include the agent component: receiving and processing messages read from the inbox and messages sent from the process to other processes; and, outputting data elements determined from processing the messages to the user interface.

Embodiments of the disclosure will now be described, by way of example only, with reference to the accompanying drawings.

### BRIEF DESCRIPTION OF THE DRAWINGS

In the drawings:

FIG. 1A is a schematic diagram which illustrates an exemplary system for software development according to aspects of the present disclosure;

FIG. 1B is a schematic diagram which illustrates an example computing system on which the development environment of FIG. 1A may be hosted;

FIG. 2A is a schematic diagram which illustrates virtual meeting rooms according to aspects of the present disclosure;

FIG. 2B is a schematic diagram which illustrates example sub-components of agent components according to aspects of the present disclosure;

FIG. 2C is a schematic diagram which illustrates a tree-like dependency of nodes within a development environment according to aspects of the present disclosure;

FIG. 3 is a flow diagram which illustrates an example method for software development according to aspects of the present disclosure;

FIG. 4 is a flow diagram which illustrates an example method for using text to obtain text-based output from a language model;

FIG. 5 is a flow diagram which illustrates an example method for outputting a visual representation of text-based output;

FIG. 6 is a flow diagram which illustrates an example method for receiving and validating user input; and,

FIG. 7 illustrates an example of a computing device in which various aspects of the disclosure may be implemented.

### DETAILED DESCRIPTION WITH REFERENCE TO THE DRAWINGS

Aspects of the present disclosure provide a development platform for creating application software. The development platform may provide a development environment. The development environment may be a low-code development environment in which human users can write functional code for steps and/or in which the writing of those steps can be outsourced to agent components or modules. In some cases, the development environment may be a collaborative development environment. The development environment may be chat-based in that application software can be created based on voice- and/or text-based chat between various participants accessing the development platform.

The development environment uses chat and visual tools and a series of language model agents to auto-generate code and visual representations of that code in a user interface for tweaking by participants in the chat. As will be explained below, auto-generating code may use agent components that generate text-based outputs from chat text. The text-based outputs may be in the form of schema validation-based files (JSON, XML, BPML, YAML, etc.) that can be configured and converted into source code (Elixir, Erlang, etc.). The system and methods described herein may enable human users to collaborate using language model agent components to build application software.

Each of the agent components may be linked to a context of development. The context of development may define a part of a codebase under development. The part of the codebase may be associated with a particular function within the codebase. The part of the codebase may include one or more blocks of code. The term “context of development” may refer to the context of a block of code within the broader codebase. For example, the context of development may determine how the block of code fits into the larger enterprise ecosystem, system interactions, related projects, and the rationale behind previous technical and architectural decisions. Understanding the context may entail knowing the “why” behind the existence of the block of code, its role within the broader application or system, and the implications of the choices made within that block.

In some examples, the context-linked agent components may be a “primitive element” (or “functional element”) agent components in that each is associated with a primitive element (which may also be termed “functional element”) provided by the development environment. The different primitive elements, which are elaborated on in greater detail below, may define different contexts of development, for example by virtue of being a representation of a particular block of code of the codebase. Each of the primitive elements may therefore be associated with different parts of the codebase under development.

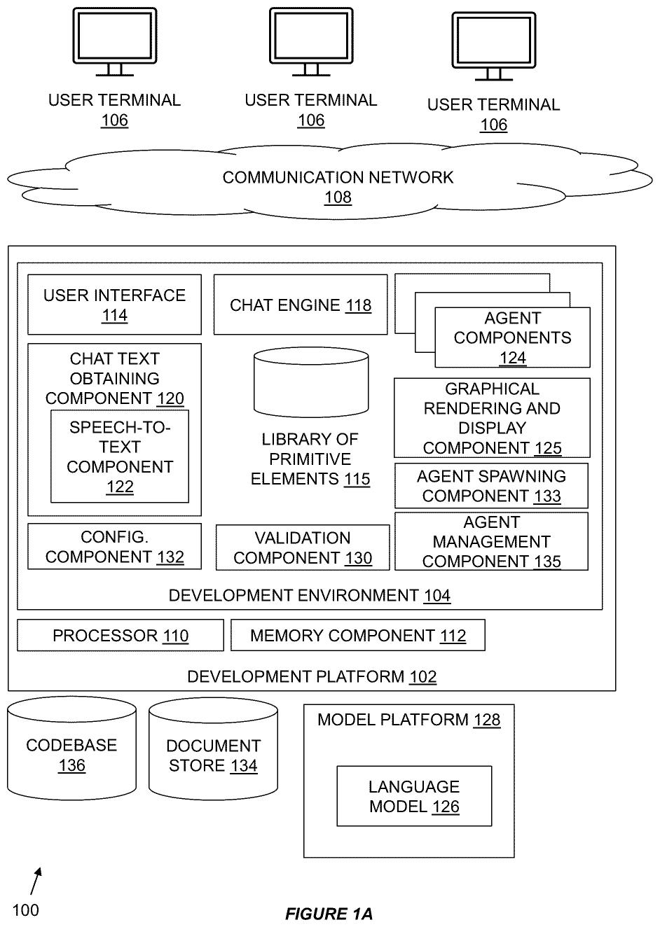

FIG. 1A is a schematic diagram which illustrates an exemplary system (100) for software development. The system includes a development platform (102) providing a development environment (104) which is accessible to a plurality of participants including human users via their respective user terminals (106) and optionally various artificial intelligence agent participants (such as the one or more agent components described herein). The development platform may be accessible to the user terminals via a communication network (108), such as the internet.

The development platform may be provided by a computing device or computing devices and may include or have access to a processor (110) for executing the functions of components described below, which may be provided by hardware or by software units executing on the development platform. The software units may be stored in a memory component (112) and instructions may be provided to the processor to carry out the functionality of the described components. In some cases, for example in a cloud computing implementation, software units arranged to manage and/or process data on behalf of the development platform may be provided remotely.

The development environment includes a user interface (114). The user interface may be displayed to the participants via their respective user terminals, which may be in the form of a computing device. The user interface may define a bounded context in the form of a space in which roles and actions, and ultimately the application software, relating to a functional unit within an organization, for example, can be described. The bounded context may be represented graphically in the user interface as a circle or other shape to which and in which actions or roles may be added and configured. The user interface includes functionality for managing actions and roles. The user interface may include functionality for managing actions against a role, setting permissions for a role, assigning agents to one or more roles and the like. Managing actions against roles may allow for control as to which agents (being users or systems) can call which actions (based on the role to which they are assigned).

The framework or structure for each of spaces, actions (or interactions), agents, roles, flows and steps within flows may be defined in respective primitive elements of the development environment. The development environment may for example include a library of primitive elements (115) including step macros. The library may include a plurality of primitive elements for each of spaces, roles, agents, interactions, flows and steps. The primitive elements for steps may be termed step macros.

Spaces may provide a container mechanism that allows one to create servers, services and/or microservices. Spaces may represent a functional unit of an organization or a collection of system-specific components. Each space is the boundary of the infrastructure where all other components are housed. Interactions (actions or reactions) connect or point to process flows. Actions are grouped by roles and are used to trigger process flows. Interactions could be considered analogous to API endpoints. Users, other spaces, or external systems may connect to roles as agents. Many agents can connect to the same role and agents can be connected to multiple roles. Roles may limit rights to specific agents that take on that role. A role is what an agent authenticates against. Roles are used to manage authentication and permissions. Flows are process flows which contain steps. A flow may be a workflow which is triggered by an action and contains the logic of how steps are connected. Steps are the building blocks of flows and may be termed building block functions. A step may define a block or snippet of functional code that is run when that part of a flow is reached. A step may take inputs from previous steps in a flow and will often result in an output being returned.

A primitive element may be provided by a schema-based validation file, which may for example be in the form of a small discrete file that has scaffolding (definitions) or shells defined in a text-based data interchange format for representing structured data based on syntax. The scaffolding tells the compiler how to operate, the version information, etc. For example, the scaffolding may be provided as JavaScript™ Object Notation (JSON™). JSON is a standard text-based format for representing structured data based on JavaScript object syntax commonly used for transmitting data in web applications. In another example, the scaffolding may be provided in Extensible Markup Language (XML), Business Process Modelling Language (BPML—an XML-based language for business process modelling), YAML (a human-readable data-serialization language) or the like.

The primitive elements may provide visual building tools associated with each of spaces, roles, agents, interactions, flows and steps. The primitive elements may be configured for user configuration and interconnection via the user interface. Visual representations of configured instances of the primitive elements may be based on or provided by the visual building tools. A configured instance of a primitive element may be in the form of a schema validation-based file including configuration parameters, details, data points or the like that govern the particular operation of that instance of the primitive element. The visual building tools may be manipulated by one or more of the plurality of participants via the user interface for configuration and interconnection of representations of building-block functions in order to generate application software.

The user interface may include functionality for connecting an action and/or reaction to a flow graph and in turn assigning one or more roles and/or agents to a flow graph. Each flow graph may be built up with a number of steps, each of which is based on a step macro.

A step macro may be made up of one or more files each of which includes one or more functions. In some cases, a step macro may also reference (or call) other files (that are not a part of the step macro) during compilation. Each step macro may be configured for user configuration and interconnection via the user interface to generate source code and/or executable code. Step macros may be configured and interconnected in the user interface to build a flow graph. The flow graph may be a visual flow that is drawn in the user interface and displays how various steps in the flow reference each other. Each step in a flow may be an instance of a type of step macro that can be interconnected with other steps (being instances of the same or other types of step macros) and configured via the user interface. Each step may be associated with a block of executable code which may form a part of a larger body of code (e.g., being a particular computer program or application software that is being developed), which may include executable code of multiple steps in a flow. The flow graph may be a schematic representation of source code (e.g., in: Python, Rust, Elixir or the like) and/or executable code that is generated through configuration and interconnection of step macros.

Each flow graph may be a definition of the following components: visual instructions on how the client should display them; the control flow with order of steps with each step defining what to call next (such as a branches field, an inner routing field and a settings field, etc.); and the code modules to execute before proceeding (such as the code modules to execute in combination with the configuration values before proceeding). The visual instructions and the control flow may be combined and leveraged to allow for the visual modelling and defining of the logic of the code around the modules that are actually executed. The development environment described herein may be configured to derive a visual representation of code, the flow graph, from the code itself.

The development environment may include a chat engine (118) which provides a chat function for chat between the participants accessing the development environment. The chat engine may provide one or more of text chat, voice chat, video chat, virtual environment-based chat (such as through avatars in the metaverse) or the like. The chat engine allows participants to chat with one another while viewing the user interface displayed via their respective user terminals. The user interface may be in the form of a shared screen or may include a shared area or zone which is visible to all participants in the chat. In this manner, manipulation, for example, of a graphical element within the user interface by one participant may be simultaneously visible to the other participants.

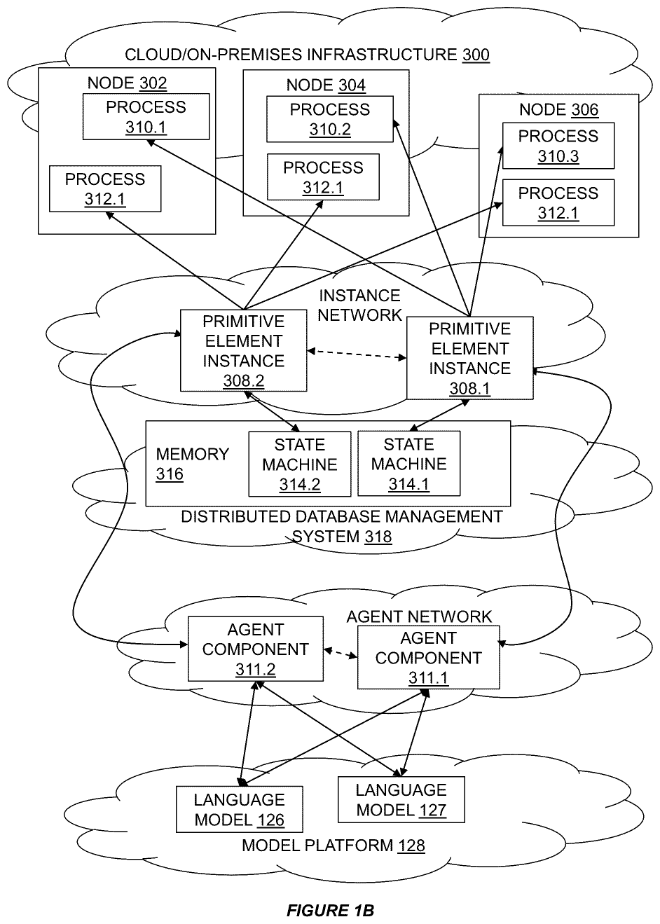

Referring to FIG. 2A, the development environment may define and manage one or more virtual meeting rooms (140, 142, 144), each of which is accessible by a number of participants via their respective user terminals. The chat engine provides the chat function to participants in that meeting room and the user interface displays a shared area or zone (145, 147, 149) visible to participants in that meeting room. In this manner, different groups of participants may collaborate through different virtual meeting rooms to build out different aspects of the application software under development.

The development environment may include a chat text obtaining component (120) for obtaining chat text from the chat between the participants. The chat text obtaining component may obtain chat text for each of the one or more virtual meeting rooms. The chat text obtaining component may run separately for each of the one or more virtual meeting rooms. The chat text obtaining component may interface with the chat engine to obtain a transcription of the chat in real-time during the chat between participants. The chat text obtaining component may include a speech-to-text component (122) which converts any voice-based chat into text. In this manner a textual representation of the chat between participants is available to the development environment in real-time.

The development environment may include a plurality of agent components (124). Each of the agent components may be an artificial intelligence-based agent component configured to perform a specific task within the development environment and to generate an output associated with that task for use by another agent component or other components of the development environment. One agent component may call another agent component. Agent components may input their outputs into other agent components.

At least a subset of the plurality of agent components may be primitive element agent components (124A-124F). Each of the one or more primitive element agent components is associated with a primitive element of the development environment. In this manner, there may be a primitive element agent component for each of: spaces, roles, agents, interactions, flows and steps. Each of the primitive element agent components is configured to receive text from the chat text obtaining component; to use the text to obtain a text-based output relating to the primitive element; and to output a visual representation of the text-based output to the user interface for interaction therewith by one or more of the plurality of participants via the user interface. In the case of the development platform providing multiple virtual meeting rooms, output of the visual representation of the text-based output may be to the shared area or zone of that meeting room being displayed to participants in the virtual meeting room. Output of the visual representation of the text-based output may be via a graphical element rendering and display component (125) of the development environment.

The primitive element agent components may be configured to obtain the text-based output from a language model (126) accessible to the development environment and configured for the primitive element.

The language model may be a probability distribution over sequences of words. The language model may include a neural network, such as a deep neural network, with many parameters (e.g., in the order billions of weights, or more). The language model may be trained on large quantities of unlabeled text, for example using self-supervised learning or the like. The language model may be a large language model (LLM). The language model may be an artificial intelligence chatbot built on top of a large language model. In one example embodiment, the language model is a generative pre-trained transformer- (GPT-) type model. Other embodiments may use other types of language models. The language model may be one having been pre-trained on a vast amount of text from the open internet or the like. When given a prompt with just a few examples, the language model may be able to intuit the task to be performed and generate a plausible completion.

The language model may be configured for the primitive element through prompting (e.g., through specific prompt language that relates to and provides explanations and context around the primitive element, sometimes called “few-shot” learning). Say, for example, a prompt relating to a business model—say an ecommerce business—is to be provided for the language model to output, inter alia, the roles and actions, etc. Configuring the language model for the primitive element in this case may include providing a number of expected text-based outputs (e.g., in JSON or other format) and saving them for later. When an agent component is spawned it can be connected to this pre-saved prompt plus example. This may obviate needing to re-prompt these examples and the agent component will be able to reference them. In this manner, when the language model is given additional prompt inputs, it will have ‘learned’ how to structure its output based on the saved prompts.

In some cases, the language model may be configured for the primitive element through fine-tuning or other processes such that the model is specifically trained for the particular primitive element with which it is associated. Fine-tuning the language model may include using a data structure including a mapping of sample prompts relating to that primitive element to sample text-based outputs relating to the sample prompts. Fine-tuning a language model may generate a variant of the language model that is fine-tuned for a specific task, for a specific primitive element, or the like. Fine-tuning may improve on few-shot learning by training on many more examples than can fit in the prompt. Once a model has been fine-tuned, simpler and/or smaller prompts (e.g., prompts without examples that few-shot learning would require) can be used to save costs and enable lower-latency requests. At a high level, fine-tuning may entail: preparing and uploading training data; training a variant of the language model in the form of a new fine-tuned model; and, using the variant of the language model.

In this manner, the development environment may have access to one or more variants of the language model. One or both of the language model and the one or more variants of the language model may be maintained by the development platform or may be provided by a model platform (128) which is accessible to the development platform, for example via an API or other interface. Thus, in some implementations, the development environment has access to a plurality of variants of the language model, each of which is configured for a primitive element with which it is associated.

In some embodiments, each of the one or more primitive element agent components may have access to a variant of the language model configured for the primitive element with which it is associated. In other words, different primitive element agent components may have access to different variants of the language model, each of which is configured for the primitive element with which that primitive element agent component is associated.

Each of the one or more primitive element agent components may be configured to: receive user input in relation to the text-based output of the language model; and, to update or adjust the text-based output based on the user input and/or input into the language model the user input as feedback on the text-based output generated for the prompt.

Referring now to FIG. 2B, each of the one or more primitive element agent components (124A-124F) may include a prompting component (152) configured to: compile a prompt based on the text; and, input the prompt into the language model. Compiling the prompt may include inserting the text or one or more keywords or key phrases derived or obtained therefrom into placeholders of a predefined prompt. The predefined prompt may be specific to the primitive element with which the primitive element agent component is associated.

Each of the one or more primitive element agent components may include a model output receiving component (154) configured to receive a text-based output from the language model. Different variants of the language model for each of the different primitive element agent components may generate different formats of text-based output, including one or more of: a list of roles; a list of actions; a list of agents; and, one or more configured instances of the primitive element.

In some cases, for example, the text-based output may include a configured instance of the primitive element. The configured instance may be configured in accordance with the text. In some cases, the configured instance of the primitive element may be partially configured in that further configuration by a participant, e.g., via the user interface, may be possible.

Each of the one or more primitive element agent components may include an output component (156) configured to output, via the graphical element rendering and display component, a graphical element in the form of a visual representation of the configured instance of the primitive element to the user interface. The visual representation of the configured instance of the primitive element is output for further configuration via the user interface. The output component of each of the one or more primitive element agent components may be associated with permissions which may be toggled between enabled and disabled to either enable or disable output of a graphical element.

The text-based output may be in the form of a schema validation-based file representing structured data. The schema validation-based file may define user-input fields and associated validation rules for the user-input fields for further configuration via the user interface.

Accordingly, the graphical element rendering and display component may be configured to: receive text-based output in the form of the schema validation-based file from the model output receiving component; generate a graphical element in the form of a visual representation of the schema validation-based file based on display rules configured to define how the user interface displays the graphical element, including display of user-input fields for receiving user input associated with the graphical element; and, output the graphical element to the user interface.

The user-input may include data points entered into a user-input field of the configured instance of the primitive element. The development environment may include: a validation component (130) configured to validate the user input based on validation rules of the primitive element; and a configuration component (132) configured to: generate configuration values (such as JSON configuration values) based on validated data points; and convert the configuration values into configuration code based on the validated data points.

Each of the one or more primitive element agent components may include a communications component (158) configured to communicate text-based outputs of the language model to participants via one or more of: chat via the chat engine; a third-party messaging application; email; SMS message; or the like. The communications component of each of the one or more primitive element agent components may be associated with permissions which may be toggled between enabled and disabled to either enable or disable communication of text-based outputs to participants.

Each of the one or more primitive element agent components may include a permission component (159) configured to check permissions managed in association with components thereof.

The development environment may include an agent spawning component (133) and an agent management component (135). The agent spawning component may be configured to spawn agent components, which may include creating an instance of an agent component. Each instance of an agent component may be bounded by or linked to a particular context. For example, an agent component that is spawned for an instance of a primitive element may be bounded by or linked to the context of that instance of the primitive element. The agent spawning component may make use of instances of agent components for the purpose of spawning new instances.

The agent management component may be configured to manage the plurality of spawned (i.e., living) agent components, for example by switching different agent components between active and passive modes of operation based on a changing context within the development environment. Managing the agent components may include managing permissions of the respective agent components, for example by changing permissions relating to outputting visual representations of text-based output to the user interface. The permissions may for example be toggled between enabled (in which case visual representations can be output) and disabled (in which case visual representations cannot be output). In some cases, managing the agent components may include managing the manner in which text-based outputs are communicated, for example either through visual representations thereof or through a communications system that alerts participants to the outputs for consideration and/or action by a participant.

In the case of instances of primitive element agent components, an instance operating in an active mode of operation may have permission to output visual representations of text-based output to the user interface. An instance of a primitive element agent component operating in a passive mode of operation, on the other hand, may not have permission to output visual representations of text-based output to the user interface, and may instead store such text-based outputs and trigger a notification or message via the communications component which prompts the participants to review the output and optionally change context to the context of the instance of the primitive element with which it is associated.

For example, the agent spawning component may spawn a primitive element agent component for each instance of a primitive element created in the development environment. While participants are working on a particular instance of a primitive element, the primitive element agent component spawned for that instance of the primitive element may operate in an active mode in which visual representations (e.g., in the form of graphical elements) of text-based outputs are output to and rendered visually on via the user interface for participants to interact with. In other words, while active in the active mode of operation, the primitive element agent component may actively contribute to the development process. While this occurs, other agent components spawned for other instances of other primitive elements may operate in a passive mode. In this mode, they may continue to receive text from the chat as well as other inputs and may continue to obtain text-based output from the language model or variants thereof. However, in the passive mode of operation, such text-based outputs may be stored and/or communicated to participants for review and/or consideration before being visually rendered and contributing to the codebase.

In response to participants moving to work on another instance of a primitive element (for example by selecting, clicking on or discussing in chat a particular instance of a primitive element), and thus changing the context, the agent management component may be configured to switch the primitive element agent component spawned for the instance of the primitive element which is now the focus to the active mode and to switch the previously active primitive element agent component to the passive mode.

Initially, and referring now to FIG. 2C, in use of the development environment to build a given piece of application software (i.e., a given application), there may be one type of agent component for each primitive element. There may for example be an instance of space agent component (161A) for a space (160A): an instance of a role agent component (161B) for a role (162A); an instance of an interaction agent component (161C) for an interaction (164); an instance of a flow agent component (161D) for a flow (166); an instance of a step agent (161E) for a step (168).

However, as development progresses, the application can be defined as a treelike construct, where the tree can have more spaces (160B-160H), which in turn, contain roles (162B-162C), which in turn contain interactions, which in turn contain flows, which in turn contain steps. It should be appreciated that although limited numbers of spaces, roles, interactions, flows and steps are illustrated in FIG. 2C, a practical application of the development environment described herein may support a plurality of each of these, with each of the plurality of spaces having a plurality of roles, each of the plurality of roles having a plurality of interactions, and so on. As these primitive elements are deployed, an instance of a primitive element agent component may be spawned for that primitive element instance in that context. By switching between contexts, the different instances may be activated or brought into a foreground mode of operation depending on the context to which the instance of the agent component is bound.

In this manner, as participants collaborate down the line, they can navigate to different parts (nodes) of the tree, and in so doing they change the context of where they collaborate as a group. Each node is either a space, role, interaction, flow, or step. So, wherever a participant (or a meeting of participants) moves to a node, there will be a ‘local’ agent component associated therewith which is configured to assist in the building or altering of that primitive element. As participants move through different contexts, the agent components continue to live in perpetuity while they observe activity and provide direct feedback about that node through chat, or even by messaging. It also provides information by documenting the ‘code’, making improvement suggestions and many more functions.

It should be appreciated that different groups of participants may collaborate on different nodes of the application software at any given time. For example, there might be a group of participants in a virtual meeting room (e.g., 140) working on a space (e.g., 160A) and another group of participants in another virtual meeting room (e.g., 142) working on another space (e.g., 160B).

In a large project there could be thousands of these primitive agents available at all times. So at the beginning of a project there may be one instance of a primitive element agent component for each of the primitive elements of the development environment at the top layer; but as development progresses, further instances of agent components will be spawned, one additional one for each node in the tree, that will be long-lived and available when needed.

Changing context within the development environment may be via the user interface. This may be through clicking in a different area of the user interface (e.g., by clicking on a visual representation of a role or a step, etc.), based on certain keywords or key phrases in the chat (e.g., “Hey Trixta, let's discuss roles” to activate a primitive element agent component for roles), or the like. In some cases, the one or more primitive element agent components can be toggled between active and passive modes of operation based on keywords present in the text. Text from the chat text obtaining component may be streamed to the agent components on a continual basis for continual operation of the agent components.

Remaining agent components (124G-124J) may for example include one or more of: a chat text processing agent (124G) for summarizing chat text to output key words, key phrases and/or summaries; a document ingesting agent (124H) for ingesting and summarizing, analyzing and/or learning from documents contained in a document store (134) accessible to the development platform; a codebase agent (1241) for ingesting and analyzing a codebase (136) of existing source code for application software having been previously developed; a prompting agent (124J) for generating prompts based on chat text and/or summaries of chat text (e.g. as provided by the chat text processing agent); a documentation agent (124K) for documenting code as it is generated and the like.

The above-described agent components are examples only, and many other types of agent components may be provided. The agent components described herein may be configured to spawn or create additional agent components. There may accordingly be a plurality of agent components, with the total number being dynamic based on needs determined by different agent components. The agent components may be long-lived in that once spawned they remain active, although permissions may be used to switch agent components between active and passive modes of operation which change the way in which these agent components interact with participants. Some of the agent components may be functional agent components in the form of third-party services configured to perform specific functions.

Referring now to FIG. 1B, the development environment may execute on a cloud or on-premises computing infrastructure (300), which may be made up of one or more nodes (302, 304, 306), each of which is provided by a computing device. Each primitive element instance (308.1, 308.2) may be embodied by a process (310, 312) and each process may be replicated across the one or more nodes such that a plurality of each of the processes (310.1, 310.2, 310.3, 312.1, 312.2, 312.3) execute across the plurality of nodes. Each of the processes may be analogous to an actor implemented by a function in a multi-actor model. Each process is addressable by and can address the other processes with which it is associated for sending and receiving messages. Each of the processes may be configured to communicate with each other by sending and receiving messages.

The messages may be received in a mailbox and stored in the order in which they are received. The messages may be stored until a receiving process takes them out to be read. In this manner, the processes implement asynchronous message passing. The processes described herein may be configured to share no state with each other. An estimated minimal overhead for each process is about 300 words, which means that many processes can be created without degrading performance. As the processes communicate using message passing instead of shared variables, any need for explicit locks may be obviated. In some examples, inter-process communication may work via a shared-nothing asynchronous message passing system. This may entail every process having a mailbox to define a queue of messages that have been sent by other processes and not yet consumed. A process may use a receive primitive to retrieve messages that match desired patterns. A message-handling routine may test messages in turn against each pattern, until one of them matches. When the message is consumed and removed from the mailbox the process resumes execution. A message may comprise any structure, including for example primitives (such as integers, floats, characters, atoms), tuples, lists, functions and the like.

Each primitive element instance (308.1, 308.2) may be allocated a portion of memory (316) dedicated to the underlying process and which represents a state machine (314.1, 314.2) for the primitive element instance. The memory (316) in which the portion of memory may be allocated may be provided by a distributed database management system (318) accessible by the one or more nodes. The state machine for a primitive element instance may be updated in response to receiving a message from another process. The update may be based on content of the message. The updated state machine is accessible to the one or more nodes executing the process. The state machine may store contextual information usable by an associated agent component in processing messages to obtain actions.

It follows that for each primitive element instance (308.1) that is associated with one or more other primitive element instances (308.2), the underlying process (310) of that primitive element is associated with one or more other processes (312) based on the association between the primitive element instances such that messages can be exchanged between the process and the other processes.

Each primitive element instance is associated with an agent component (311.1, 311.2). The development environment is configured to create an agent component (e.g. 311.1) associated with a primitive element instance (e.g. 308.1) when the primitive element instance is created from a corresponding primitive element template. In this manner, each primitive element instance has its own agent component. Each agent component is unique to the primitive element instance for which it is created and persists for as long as the primitive element instance persists. Each agent component may itself be a process which may execute on the one or more nodes and able to communicate with other processes via messaging.

Agent components may have access to one or more language models (126, 127). The language models may be large language models (LLMs). The language models may be provided by the model platform (128) and may for example be accessible via API or other interface. In some cases, bespoke language models are provided for agent components of specific primitive element types. In some examples, certain types of agent component have access to certain types of language models. For example, agent components associated with higher-level primitive element instances may have access to more powerful, general purpose language models. Agent components associated with lower-level primitive element instances may have access to smaller, less powerful and in some cases more specific language models. The language models may be configured to generate outputs in a schema validation-based format representing structured data.

The agent components described herein may serve various functions, including performing one or more actions. For example, they may aid the development team during the creation and refinement of the application by offering intelligent suggestions, thereby increasing efficiency and reducing potential errors. Secondly, they may interact with operational users, helping them navigate and make the most of the application's functionalities. For instance, agent components can take input from users, guide them through complex workflows, or provide them with relevant information as needed. Importantly, these agent components are not transient or session-based; they are long-living entities that exist for as long as the application itself. This constant presence of agent components may help provide a persistent level of support and guidance for users and builders alike. In some examples, an operational user may be able to adapt a software application using the various long-lived agent components described herein specifically for their personal needs. For example, in an application which has 5 million users, the systems and methods described herein may permit an operational user of the application to extend and adapt their app and services (provided it still operates in the same at the backend). In this manner, an operations user could describe the software they need to facilitate hyper-personalization.

The application development environment described herein may be distributed, fault-tolerant, real-time, highly available and configured for live updates to a block of code which can be propagated through other blocks of code automatically with little to no human intervention.

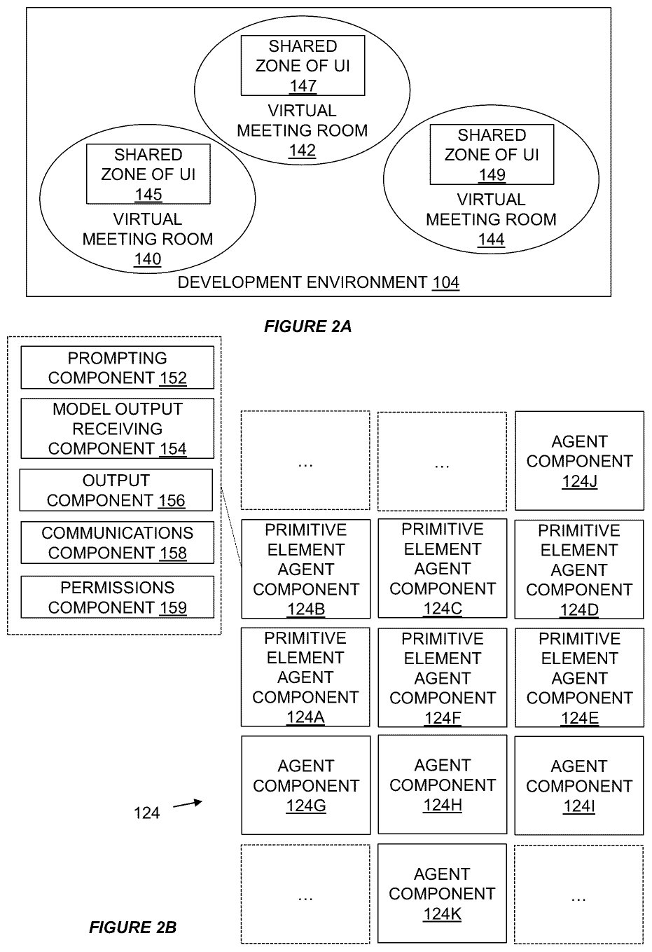

The system (100) described above may implement a method for software development. An exemplary method for software development is illustrated in the flow diagram of FIG. 3. The method may be conducted by one or more computing devices.

The method may include providing (202) a chat function for chat between participants accessing a development environment via respective user terminals. The method may include tracking context and updating (203) permissions of the one or more primitive element agent components based on an area or context of collaboration by the participants. This may include switching primitive element agent components between active and passive modes of operation based on a current context of collaboration. Contexts of collaboration may be changed for example by participants selecting, clicking on, editing or discussing a particular space, role, agent, interaction, flow or step. A context of collaboration may be the particular space, role, agent, interaction, flow or step that is being worked on by participants in a given virtual meeting room.

The method may include obtaining (204) chat text from the chat between the participants. The participants may access the development environment via a virtual meeting room. The chat function may be for participants in the virtual meeting room. A shared area or zone in the user interface may be visible to all participants in the virtual meeting room. The chat may include voice chat and obtaining chat text from the chat between the participants may include converting (206) the voice chat into text.

The method may include inputting (210) the text into each of one or more primitive element agent components, each of which is associated with a primitive element. It should be noted that the same text conversations can be input for different types of primitive element agent components as the different primitive element agent components may perceive different functional elements based on the identical text inputs. As will be explained, prompts may be constructed specifically for the agent components. In some implementations, there may be intermediate agent components configured to construct prompts from text specifically for a certain type of primitive element agent component. Inputting the text into each of the one or more primitive element agent components may include inputting the text via a chat text processing agent (124G) which generates summaries, keywords and/or key phrases from the text for input into the primitive element agent component(s).

The method may include each of the one or more primitive element agent components receiving (214) text from the chat between the participants and using (222) the text to obtain a text-based output relating to the primitive element, including obtaining the text-based output from a language model configured for the primitive element. Receiving the text from the chat between participants may include receiving summaries, keywords and/or key phrases of or obtained from the text from a chat text processing agent. Additionally, receiving the text from the chat between participants may include receiving contextual data relating to the chat text, for example information or insights relating to documentation and/or a codebase obtained from a document ingesting agent (124H), a codebase agent (1241), or the like. The text that the primitive element agent component receives may therefore be enriched text that includes chat text and context around the chat text.

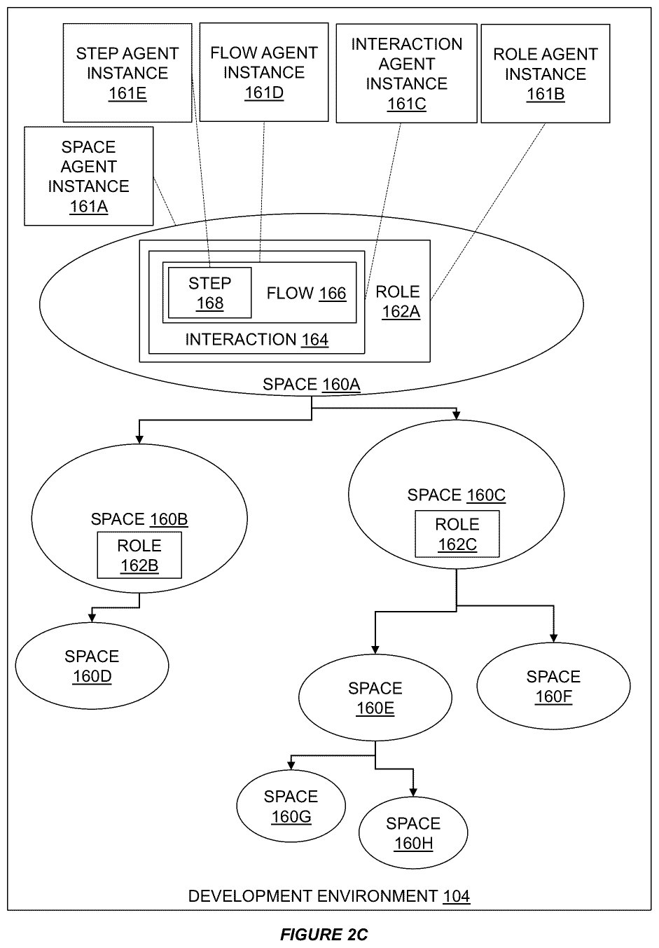

With reference to FIG. 4, using (222) the text to obtain the text-based output may include each of the one or more primitive element agent components: compiling (250) a prompt based on the text; inputting (252) the prompt into the language model; and receiving (254) the text-based output from the language model. Compiling the prompt may include inserting the text or one or more keywords or key phrases obtained therefrom into placeholders of a predefined prompt. The predefined prompt may be specific to the primitive element with which the primitive element agent component is associated. In some cases, compiling the prompt may include using a prompting agent (124J) which generates prompts based on the text. In some cases, different variants of the language model for each of the different primitive element agent components may generate different formats of text-based output, including one or more of: a list of roles; a list of actions; a list of agents; and, a configured instance of the primitive element. The text-based output may thus include a configured instance of the primitive element, the configured instance being configured in accordance with the text having been input into the primitive element agent component. In some cases, using the text to obtain the text-based output may be interactive with the language model (or variant thereof) asking the participant for more information, clarifications or the like. The method may therefore include, for an active primitive element agent component, outputting (253A) via the communication interface questions, requests, etc. received from the language model; receiving (253B), via the communication interface, a participant's response thereto; and, inputting (253C) the participant's response into the language model. These steps may repeat until the language model (or variant thereof) is able to generate a text-based output based on the text (and any additional context obtained from participants, other agent components, or the like).

Returning to FIG. 3, depending on permissions (224) set for the primitive element agent component, the method may include each of the one or more primitive element agent components: outputting (226) a visual representation of the text-based output to a user interface of the development environment being displayed on each of the user terminals; and/or, outputting (228) the text-based output or a notification relating to the text-based output to participants via a communications component. Outputting the visual representation of the text-based output to the user interface of the development environment enables interaction therewith by one or more of the plurality of participants via the user interface. The output may be in real-time, such that the visual representation is output to the user interface shortly (within a few seconds, or less) after the participants have discussed requirements relating to it. Output of the visual representation may be to a shared area or zone that is visible to all participants in a virtual meeting room. As mentioned, the text-based output may be a configured instance of a primitive element and outputting a visual representation of the text-based output may include outputting a graphical element in the form of a visual representation of the configured instance of the primitive element to the user interface. The visual representation of the configured instance of the primitive element is output for further configuration via the user interface. Output of the text-based output or a notification relating thereto via the communications component may include sending a message or notification to alert one or more participants to the text-based output and prompting the participants to review and interact with the output.

In the case of a primitive element agent component operating in a background mode of operation, and thus having permissions set which require output via the communications component, the primitive element agent component may wait for permissions to change, indicating a change of context to one which relates to that primitive element agent component, and then output the visual representation of the text-based output to the user interface. In this manner, outputting via the communications component can prompt a change of context.

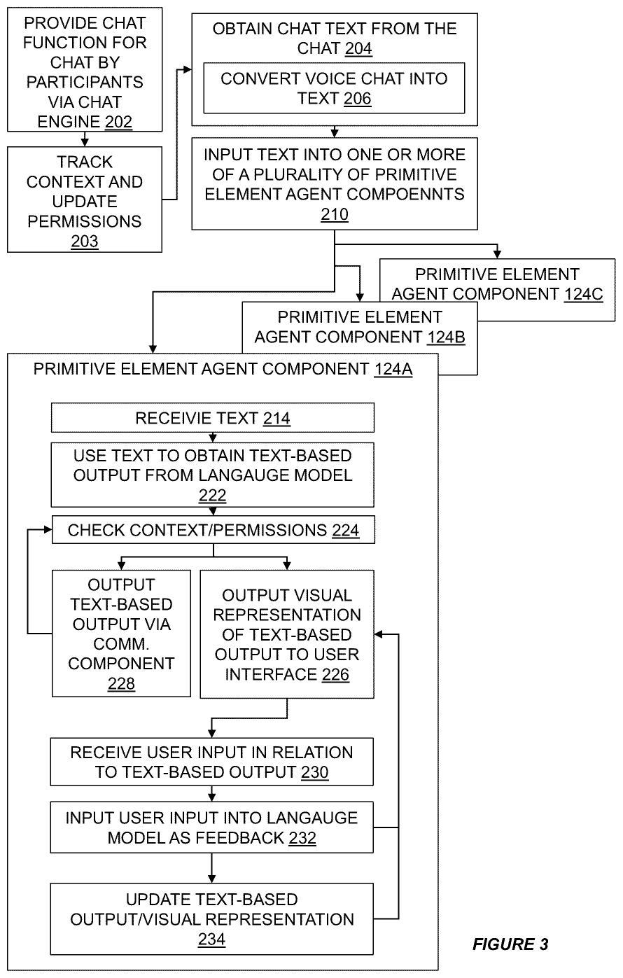

The text-based output may be in the form of a schema validation-based file representing structured data. The schema validation-based file may for example define user-input fields and associated validation rules for the user-input fields for further configuration via the user interface. The method may include, referring now to FIG. 5, receiving (260) the schema validation-based file; generating (262) a graphical element in the form of a visual representation of the schema validation-based file based on display rules configured to define how the user interface displays the graphical element, including display of user-input fields for receiving user input associated with the graphical element; and, outputting (264) the graphical element to the user interface. In this manner, text-based output in the form of language constructs such as JSON, XML, BMPL, YAML or the like can be used as inputs into visual display elements for graphically rendering a visual representation of the text-based outputs.

In this manner, if a primitive element agent component is operating in an active mode of operation, text-based output in the form of schema validation files representing structured data may be rendered and output in real-time as a graphical element in the form of a visual representation of the file. This provides visual tools in the user interface relating to a specific context for participants to manipulate and configure while discussing that context. However, as primitive element agent components relating to other contexts, operating in a passive mode of operation, are also receiving the text from the chat between participants, such passive agent components can monitor the chat and, if necessary, generate text-based output relating to that primitive element and its context based on the text chat and notify participants of that text-based output for their review and consideration.

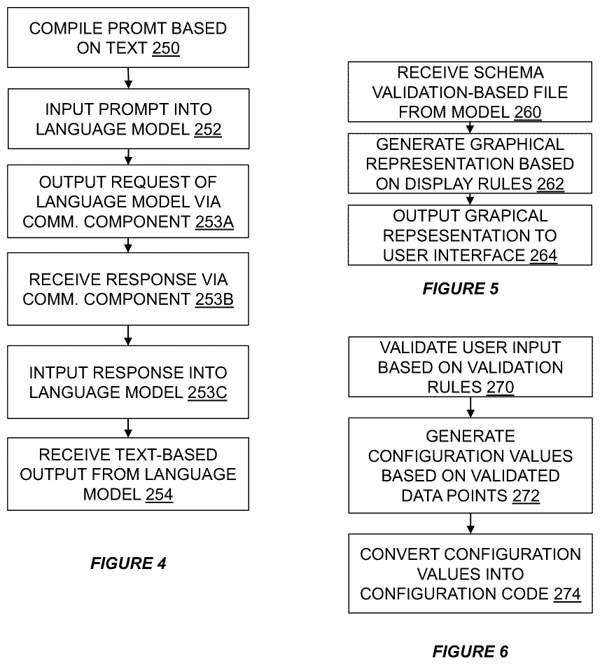

Returning to FIG. 3, the method may include each of the one or more primitive element agent components receiving (230) user input in relation to the text-based output of the language model. The user input may have been input into the development environment via the chat engine or via the user interface (e.g., by way of clicking on one or more graphical elements, typing, etc.). The method may include each of the one or more primitive element agent components inputting (232) into the language model the user input as feedback on the text-based output generated for the prompt. This may for example include using the user input text to obtain an updated text-based output from the language model. The method may include each of the one or more primitive element agent components updating (234) or adjusting the text-based output and/or the visual representation of the text-based output based on the user input. This may for example be in the form of adding to or completing the text-based output and/or visual representation thereof, for example, by adding connections to other steps or flows, adding configuration and related data points or the like. For example, in some cases, and referring now to FIG. 6, user-input may include data points entered into a user-input field of a configured instance of the primitive element, and the method may include: validating (270) the user input based on validation rules of the primitive element; generating (272) configuration values (such as JSON configuration values) based on validated data points; and, converting (274) the configuration values into configuration code based on the validated data points.

The configuration code can be converted into source code based on components of the step macro which are described in greater detail in the Applicant's U.S. Pat. No. 11,561,772 B2, the entire content of which is incorporated by reference herein for all purposes.

The system and method described herein provide a collaborative development environment for the development of application software by multiple participants. Chat between participants, who may for example be in a virtual meeting room provided by the development environment, is used to autonomously generate visual representations of blocks of software code (as well as the underlying blocks of code) that are output to a shared user interface (or a shared area or zone of a user interface) for review and manipulation by one or more of the participants. The autonomous generation of the visual representations may be via agent components which receive text based on the chat between participants and generate text-based output that defines the visual representations and generation of the underlying blocks of code. Manipulation of the visual representations through input by the participants may update the visual representations themselves as well as the underlying blocks of code and may further provide input to the agent components having autonomously generated the text-based output on which the visual representations and blocks of code are based. Multiple virtual meeting rooms may be provided for multiple teams to collaborate on the development of the same application software.

### EXAMPLES

In an example use case, a primitive element agent component may receive text from chat between participants as follows:
Michael: How are you doing
Jack: Good, Good, yeah, you?
Michael: Pretty good. Cool, so let's get at it. What is the system you want to build?
Jack: Oh, ok, yeah. I want to create a platform for buying second hand furniture from people in the US. And then fixing them and reselling them.
Michael: Nice. Do you plan to build a team of people to fix them?
Jack: No, no. I want to create a network of people who would fix them
Michael: So you would buy from people in different locations, but maybe have repair people in different places?
Michael: exactly.

The primitive element agent component may use the text to obtain text-based output from a language model, for example by compiling the following prompt based on the text:
“From the above conversation, we want to build a complete software platform. Come up with a full list of every user role, admin role and system role needed for a platform like this. For each role come up with every action that role would need to execute on a platform like this. Express all these roles and actions in a JSON object with “roles” and “actions”. Do not have any leading or trailing text—just the JSON.”

The primitive element agent component may receive text-based output from the language model as follows:

```
{
  “roles”: {
    “system_admin”: {
      “actions”: [
        “CreateUser”,
        “EditUser”,
        “DeleteUser”,
        “ViewUser”,
        “CreateRole”,
        “EditRole”,
        “DeleteRole”,
        “ViewRole”,
        “ApproveFurniture”,
        “RejectFurniture”,
        “ApproveRepairPerson”,
        “RejectRepairPerson”,
        “ManagePricing”,
        “ViewReports”,
        “ManageSystemSettings”
      ]
    },
    “furniture_seller”: {
      “actions”: [
        “PostFurniture”,
        “EditFurniture”,
        “DeleteFurniture”,
        “ViewOwnFurniture”,
        “ViewPricing”,
        “ConfirmSale”,
        “ViewSaleHistory”,
        “RateBuyer”,
        “RateRepairPerson”,
        “ContactSupport”
      ]
    },
    “furniture_buyer”: {
      “actions”: [
        “ViewFurniture”,
        “BuyFurniture”,
        “RateSeller”,
        “RateRepairPerson”,
        “ViewPurchaseHistory”,
        “ContactSupport”
      ]
    },
    “furniture_repair_person”: {
      “actions”: [
        “ViewAssignedFurniture”,
        “UpdateRepairStatus”,
        “RateSeller”,
        “RateBuyer”
        “ViewRepairHistory”,
        “ContactSupport”
      ]
    }
  }
}
```

Depending on the mode of operation of the primitive element agent component, the text-based output may either be output to participants via a communication component (e.g. via text message, email or other notification) or may be output to the user interface for further interaction by the participants (e.g. to select or reject identified roles, actions, etc.).

In another example, a primitive element agent component may obtain the following prompt for obtaining text-based output from the language model:
“I want to build a software platform that runs a series of butcheries around the US, with centralized ordering and warehousing points and distribution. Please return all the admin and user roles you would expect to see in a platform like this. Return the list as a JSON object that simply lists each role”

And the primitive element agent component may receive text-based output from the language model along the following lines:

{
“roles”: [
{
“role”: “Super Admin”,
“description”: “Responsible for overall platform management, access control, and high-level
decision-making.”
},
{
“role”: “Regional Manager”,
“description”: “Oversees multiple butcheries within a region, manages regional operations, and
ensures compliance with regulations and standards.”
},
{
“role”: “Butchery Manager”,
“description”: “Manages the day-to-day operations of a single butchery, including staffing,
inventory, and customer service.”
},
{
“role”: “Warehouse Manager”,
“description”: “Responsible for managing the centralized warehousing point, including inventory
control, order processing, and coordination with distribution.”
},
{
“role”: “Distribution Manager”,
“description”: “Oversees the distribution network, coordinates with warehouses and butcheries to
ensure timely deliveries, and manages logistics.”
},
{
“role”: “Butcher”,
“description”: “Responsible for processing and preparing meat products according to customer
orders and industry standards.”
},
{
“role”: “Customer Service Representative”,
“description”: “Assists customers with inquiries, processes orders, and handles any issues that
may arise.”
},
{
“role”: “Inventory Specialist”,
“description”: “Monitors and manages inventory levels at both the butchery and warehouse levels,
ensuring adequate stock is available to fulfill orders.”
},
{
“role”: “Logistics Coordinator”,
“description”: “Coordinates transportation and delivery schedules between the warehouse,
distribution centers, and butcheries.”
},
{
“role”: “Quality Assurance Inspector”,
“description”: “Ensures that all products meet quality standards and regulatory requirements, and
conducts regular audits to ensure compliance.”
},
{
“role”: “Sales Representative”,
“description”: “Responsible for acquiring new business and maintaining relationships with existing
customers.”
},
{
“role”: “IT Support Specialist”,
“description”: “Provides technical support for the platform and assists users with any issues they
may encounter.”
},
{
“role”: “Financial Analyst”,
“description”: “Monitors the financial health of the platform, prepares financial reports, and assists
with budgeting and forecasting.”
},
{
“role”: “Marketing Specialist”,
“description”: “Responsible for promoting the platform and creating marketing campaigns to
attract customers and drive sales.”
},
{
“role”: “Customer”,
“description”: “Purchases products and services from the platform and provides feedback on their
experience.”
}
]
}

Continuing the above example, the primitive element agent component may proceed to obtain the following prompt for obtaining text-based output from the language model:
“For each role specified above, please give a list of each Action that role should be able to initiate in the platform. Please return each role and action in a JSON object.”

And the primitive element agent component may receive text-based output from the language model along the following lines:

{
“roles”: [
{
“role”: “Super Admin”,
“actions”: [
“create_roles”,
“manage_roles”,
“view_all_data”,
“manage_regions”,
“manage_butcheries”,
“manage_warehouses”,
“manage_distributions”,
“manage_users”,
“view_reports”,
“manage_platform_settings”
]
},
{
“role”: “Regional Manager”,
“actions”: [
“view_region_data”,
“manage_butcheries_within_region”,
“view_reports_for_region”,
“coordinate_with_warehouse_manager”,
“coordinate_with_distribution_manager”
]
},
{
“role”: “Butchery Manager”,
“actions”: [
“manage_butcher_staff”,
“manage_inventory”,
“view_orders”,
“process_orders”,
“coordinate_with_warehouse_manager”,
“coordinate_with_distribution_manager”,
“manage_customer_service”,
“view_reports_for_butcher”
]
},
{
“role”: “Warehouse Manager”,
“actions”: [
“manage_inventory”,
“view_orders”,
“process_orders”,
“coordinate_with_distribution_manager”,
“coordinate_with_butchery_managers”,
“manage_logistics”,
“view_reports_for_warehouse”
]
},
{
“role”: “Distribution Manager”,
“actions”: [
“view_orders”,
“coordinate_deliveries”,
“manage_logistics”,
“coordinate_with_warehouse_manager”,
“coordinate_with_butchery_managers”,
“view_reports_for_distribution”
]
},
{
“role”: “Butcher”,
“actions”: [
“process_meat_products”,
“manage_individual_inventory”,
“view_orders”,
“update_order_status”
]
},
{
“role”: “Customer Service Representative”,
“actions”: [
“view_customer_data”,
“manage_customer_orders”,
“handle_customer_issues”,
“process_returns”,
“assist_with_order_inquiries”
]
},
{
“role”: “Inventory Specialist”,
“actions”: [
“monitor_inventory_levels”,
“update_inventory”,
“coordinate_inventory_replenishment”,
“generate_inventory_reports”
]
},
{
“role”: “Logistics Coordinator”,
“actions”: [
“schedule_transportation”,
“track_deliveries”,
“update_delivery_status”,
“coordinate_with_distribution_manager”,
“coordinate_with_warehouse_manager”
]
},
{
“role”: “Quality Assurance Inspector”,
“actions”: [
“inspect_products”,
“conduct_audits”,
“enforce_quality_standards”,
“report_noncompliance”
]
},
{
“role”: “Sales Representative”,
“actions”: [
“acquire_new_business”,
“manage_customer_relationships”,
“track_sales_performance”,
“generate_sales_reports”
]
},
{
“role”: “IT Support Specialist”,
“actions”: [
“assist_users_with_technical_issues”,
“manage_platform_updates”,
“monitor_system_performance”,
“maintain_security”
]
},
{
“role”: “Financial Analyst”,
“actions”: [
“monitor_financial_performance”,
“prepare_financial_reports”,
“assist_with_budgeting”,
“assist_with_forecasting”
]
},
{
“role”: “Marketing Specialist”,
“actions”: [
“create_marketing_campaigns”,
“manage_social_media”,
“analyze_market_data”,
“generate_marketing_reports”
]
}

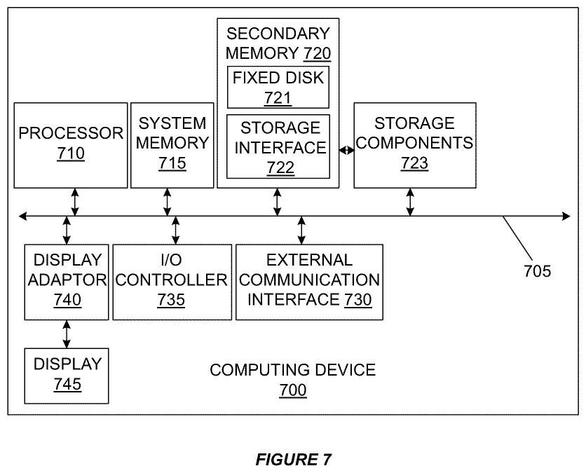

FIG. 7 illustrates an example of a computing device (700) in which various aspects of the disclosure may be implemented. The computing device (700) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (700) may be configured for storing and executing computer program code. The various participants and elements in the previously described system diagrams may use any number of subsystems or components of the computing device (700) to facilitate the functions described herein. The computing device (700) may include subsystems or components interconnected via a communication infrastructure (705) (for example, a communications bus, a network, etc.). The computing device (700) may include one or more processors (710) and at least one memory component in the form of computer-readable media. The one or more processors (710) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (700) may be distributed over a number of physical locations (e.g., in a distributed, cluster or cloud-based computing configuration) and appropriate software units may be arranged to manage and/or process data on behalf of remote devices.

The memory components may include system memory (715), which may include read only memory (ROM) and random-access memory (RAM). A basic input/output system (BIOS) may be stored in ROM. System software may be stored in the system memory (715) including operating system software. The memory components may also include secondary memory (720). The secondary memory (720) may include a fixed disk (721), such as a hard disk drive, and, optionally, one or more storage interfaces (722) for interfacing with storage components (723), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (700) may include an external communications interface (730) for operation of the computing device (700) in a networked environment enabling transfer of data between multiple computing devices (700) and/or the Internet. Data transferred via the external communications interface (730) may be in the form of signals, which may be electronic, electromagnetic, optical, radio, or other types of signals. The external communications interface (730) may enable communication of data between the computing device (700) and other computing devices including servers and external storage facilities. Web services may be accessible by and/or from the computing device (700) via the communications interface (730).

The external communications interface (730) may be configured for connection to wireless communication channels (e.g., a cellular telephone network, wireless local area network (e.g., using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (710). A computer program product may be provided by a non-transient or non-transitory computer-readable medium or may be provided via a signal or other transient or transitory means via the communications interface (730).

Interconnection via the communication infrastructure (705) allows the one or more processors (710) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (700) either directly or via an I/O controller (735). One or more displays (745) (which may be touch-sensitive displays) may be coupled to or integrally formed with the computing device (700) via a display or video adapter (740).

The foregoing description has been presented for the purpose of illustration; it is not intended to be exhaustive or to limit the technology to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any computer language such as, for example, Java™, C++, or Perl™ using, for example, conventional or object-oriented techniques. The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe embodiments in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A system comprising a non-transitory computer-readable storage medium and one or more processors coupled to the non-transitory computer-readable storage medium, wherein the non-transitory computer-readable storage medium comprises program instructions that, when executed on the one or more processors, cause the system to perform operations comprising:
providing a chat function for chat between participants accessing a development environment via respective user terminals;
obtaining chat text from the chat between the participants;
inputting the chat text into each of one or more context-linked agent components, each of which is associated with a context of development;
receiving, by each of the one or more context-linked agent components, chat text from the chat between participants and using the chat text to obtain a text-based output relating to the context of development, the text-based output being obtained from a language model configured for the context of development; and
outputting a visual representation of the text-based output to a user interface of the development environment being displayed on each of the user terminals for interaction therewith by one or more of the plurality of participants via the user interface.

2. The system as claimed in claim 1, wherein the context of development defines a part of a codebase under development which is associated with a function, wherein the part of the codebase includes one or more blocks of code.

3. The system as claimed in claim 1, wherein the context-linked agent component is a primitive element agent component associated with a primitive element, wherein the primitive element defines the context of development, and wherein the primitive element is associated with the part of the codebase under development.

4. The system as claimed in claim 1, wherein the chat between the participants includes voice chat, and wherein obtaining chat text from the chat between the participants includes converting a recording of the voice chat to text.

5. The system as claimed in claim 1, wherein each of the one or more context-linked agent components has access to a language model fine-tuned based on the context of development with which it is associated.

6. The system as claimed in claim 5, wherein fine-tuning the language model includes using a data structure including a mapping of sample prompts relating to that context of development to sample text-based outputs relating to the sample prompts.

7. The system as claimed in claim 5, wherein the program instructions cause the system to perform operations including, by each of the one or more context-linked agent components, compiling a prompt based on the chat text; and, inputting the prompt into the language model.

8. The system as claimed in claim 7, wherein compiling the prompt includes inserting the chat text or one or more keywords or key phrases obtained therefrom into placeholders of a predefined prompt.

9. The system as claimed in claim 8, wherein the predefined prompt is specific to the context of development with which the context-linked agent component is associated.

10. The system as claimed in claim 5, wherein the program instructions cause the system to perform operations including, by each of the one or more context-linked agent components, receiving the text-based output from the language model.

11. The system as claimed in claim 5, wherein different variants of the language model for each of the different context-linked agent components generate different formats of text-based output, including one or more of: a list of roles; a list of actions; a list of agents; and, a configured instance of a primitive element.

12. The system as claimed in claim 11, wherein the text-based output includes the configured instance of the primitive element, the configured instance being configured in accordance with the chat text.

13. The system as claimed in claim 11, wherein the program instructions cause the system to perform operations including, by each of the one or more context-linked agent components, outputting, via a graphical element rendering and display component, a graphical element in the form of a visual representation of the configured instance of the primitive element to the user interface, wherein the graphical element is output for further configuration via the user interface.

14. The system as claimed in claim 1, wherein the text-based output is in the form of a schema validation-based file representing structured data, wherein the schema validation-based file defines user-input fields and associated validation rules for the user-input fields for further configuration via the user interface.

15. The system as claimed in claim 13, wherein the program instructions cause the system to perform operations including, by the graphical element rendering and display component:
receiving the schema validation-based file from the model;
generating a graphical element in the form of a visual representation of the schema validation-based file based on display rules configured to define how the user interface displays the graphical element, including display of user-input fields for receiving user input associated with the graphical element; and
outputting the graphical element to the user interface.

16. The system as claimed in claim 1, wherein the program instructions cause the system to perform operations including, by each of the one or more context-linked agent components:
receiving user input in relation to the text-based output of the language model; and
updating or adjusting the text-based output based on the user input and/or inputting into the language model the user input as feedback on the text-based output generated for the prompt.

17. The system as claimed in claim 16, wherein the user-input includes data points entered into a user-input field of a configured instance of a primitive element, and the program instructions cause the system to perform operations including:
validating the user input based on validation rules of the primitive element;
generating configuration values based on validated data points; and
converting the configuration values into configuration code based on the validated data points.

18. A computer-implemented method comprising:
providing a chat function for chat between participants accessing a development environment via respective user terminals;
obtaining chat text from the chat between the participants;
inputting the chat text into each of one or more context-linked agent components, each of which is associated with a context of development;
receiving, by each of the one or more context-linked agent components, chat text from the chat between participants and using the chat text to obtain a text-based output relating to the context of development, the text-based output being obtained from a language model configured for the context of development; and
outputting a visual representation of the text-based output to a user interface of the development environment being displayed on each of the user terminals for interaction therewith by one or more of the plurality of participants via the user interface.

19. A computer program product comprising a computer-readable medium having stored computer-readable program code for performing the steps of:
providing a chat function for chat between participants accessing a development environment via respective user terminals;
obtaining chat text from the chat between the participants;
inputting the chat text into each of one or more context-linked agent components, each of which is associated with a context of development;
receiving, by each of the one or more context-linked agent components, chat text from the chat between participants and using the chat text to obtain a text-based output relating to the context of development, the text-based output being obtained from a language model configured for the context of development; and
outputting a visual representation of the text-based output to a user interface of the development environment being displayed on each of the user terminals for interaction therewith by one or more of the plurality of participants via the user interface.
